(19) United States
(12) Patent Application Publication
(10) Pub. No.: US 2006/0221842 A1
(43) Pub. Date: Oct. 5, 2006

(54) Systems and methods for testing system links

(76) Inventor: Steven Wayne Terry, Irving, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/094,737

(22) Filed: Mar. 30, 2005

(51) Int. Cl. H04L 1/00

(52) U.S. Cl. 370/248; 370/252

(57) ABSTRACT

In one embodiment, a method for testing a link comprises identifying devices that are associated with a selected link, collecting information about the configuration of the identified devices, building test sequences for testing the selected link based upon the collected information, and controlling, via boundary-scan architecture, an internal test element to test the selected link.

### BACKGROUND

High-speed links are common in high-end computing systems. Such links generally comprise an interface between system devices that facilitates high-speed communication. For example, a high-speed link may be an interface between two integrated circuit (IC) chips that are provided on a circuit board of a computing system.

It is desirable to design system links to transmit information as quickly as possible so as to avoid communication bottlenecks. Given that problems can occur with such links, particularly when great communication speeds are attempted, it is often necessary to test the links to verify that they are working correctly. Problems with a link may result in data corruption or decreased performance.

There are several methods that are used to test system links. In one such method, diagnostic software is created that causes data to travel across the links so that the output from each link can be evaluated. Although this methodology is viable, it requires a large investment of time and effort in developing software that is specifically-designed for the architecture of the system being tested. In addition, such testing can normally only be conducted when the entire system is completed and running. Therefore, such testing may not be possible in early stages of system development.

Link testing can also be achieved using software to drive built-in self-test (BIST) technology. In BIST testing, pseudo-random test data is generated by a BIST engine at one end of a link (e.g., driver), the test data is sent across the link, and an output or “signature” that is determined at another end of the link (e.g., receiver) is evaluated. Although this method simplifies the test procedure, it still requires that system-specific code (e.g., firmware) to be developed. Therefore, BIST testing also requires a significant time, effort, and skill on the part of the tester. In addition, BIST testing, like diagnostic testing, may not be possible until the entire system is operational.

### SUMMARY

Disclosed are systems and methods for testing system links. In one embodiment, a method for testing a link comprises identifying devices that are associated with a selected link, collecting information about the configuration of the identified devices, building test sequences for testing the selected link based upon the collected information, and controlling, via boundary-scan architecture, an internal test element to test the selected link.

### BRIEF DESCRIPTION OF THE DRAWINGS

The systems and methods of this disclosure can be better understood with reference to the following drawings. The components in the drawings are not necessarily to scale.

FIG. 1 is a schematic view of an embodiment of test apparatus used to conduct link testing on a system under test.

FIG. 2 is a schematic view of an example embodiment for a system under test shown in FIG. 1.

FIG. 3 is a schematic view of an example embodiment of a link of the system under test shown in FIG. 2.

FIG. 4 is a block diagram of an embodiment of architecture of a device of the system under test shown in FIG. 2.

FIG. 5 is a flow diagram of a first embodiment of a method for testing a link.

FIG. 6A is a first portion of a flow diagram of a second embodiment of a method for testing a link.

FIG. 6B is a second portion of the flow chart began in FIG. 6A.

FIG. 7 is a graphical depiction of an example link model.

### DETAILED DESCRIPTION

As is described above, existing link test methodologies may require system-specific code to be created, and/or may require that the system is completed and running. As is described in the following, however, the links of system can be tested without developing system-specific code and prior to system completion using a link test system that leverages boundary scan technology. In operation, the test system automatically determines data to be loaded into internal rings of one or more devices of the system and then loads this data using the boundary-scan architecture of the system under test to enable link testing. Through use of the test system, the system links can be tested at speed to confirm that they are operating correctly.

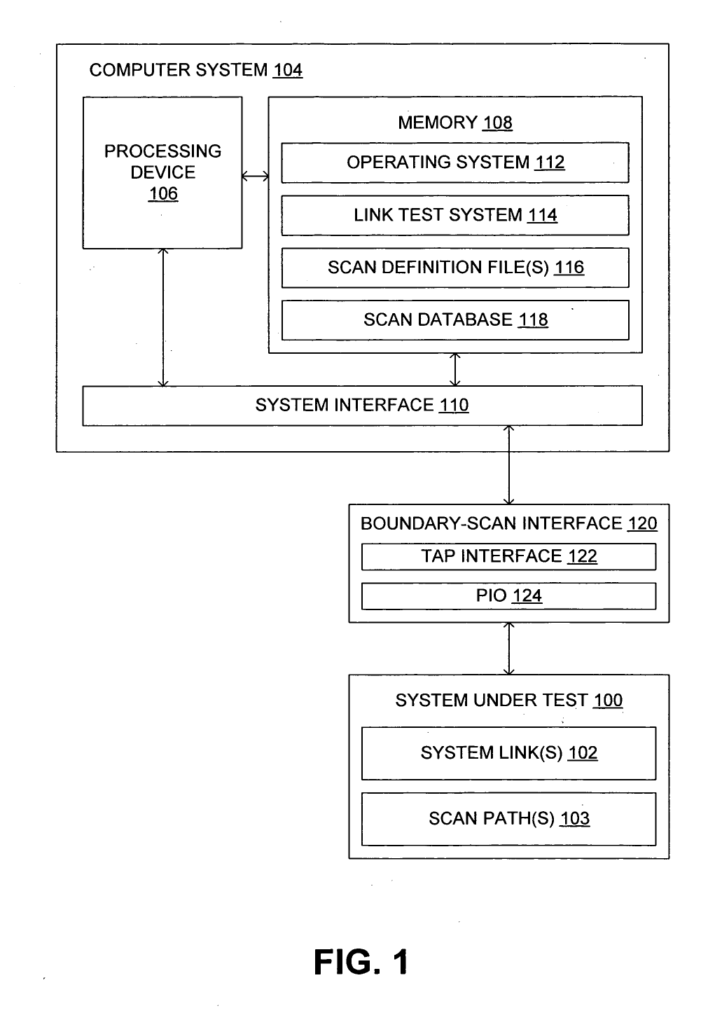

Referring now to the figures, in which like numerals identify corresponding parts, FIG. 1 illustrates test apparatus that can be used to test one or more system links 102 of a system under test 100. By way of example, the system under test 100 comprises one or more circuit boards that each includes one or more electrical components (e.g., chips) that are linked together.

In the example embodiment of FIG. 1, the test apparatus comprises a computer system 104. This computer system 104 can comprise a common computer, such as a server computer, a desktop computer (e.g., IBM- or Macintosh-compatible), or a laptop computer. The computer system 104 includes a processing device 106 that comprises, for instance, a custom-made or commercially-available processor, a central processing unit (CPU), or a semiconductor-based microprocessor.

Also included in the computer system 104 is memory 108 that can include one or more volatile memory elements (e.g., read access memory (RAM)) and one or more nonvolatile memory elements (e.g., flash memory, magnetic RAM (MRAM), etc.).

The computer system 104 further comprises a system interface 110 that includes one or more components that enable the computer system to communicate with other systems or devices, such as a boundary-scan interface 120. The boundary-scan interface 120 may be part of the computer system 104, the system under test 100, or a separate device. The components of the boundary-scan interface 120 may comprise, for example, a Personal Computer Memory Card International Association (PCMCIA) card. When provided, the boundary-scan interface 120 acts as an intermediary between the computer system 104 and the system under test 100, and provides a means for facilitating control of scan paths 103 of the system under test 100. As is illustrated in FIG. 1, the boundary-scan interface 120 can include, for example, a test access port (TAP) interface 122 and a programmed input/output (PIO) 124.

The memory 108 comprises various programs, for example in software, including an operating system 112 and a link test system 114. The operating system 112 controls the execution of other programs and provides scheduling, input-output control, file and data management, memory management, and communication control and related services. The link test system 114 may be part of some scan software or exist as a stand-alone body of code, and is configured to automatically determine the information that must be provided to one or more devices of the system under test 100 to enable testing of the system links 102. In some embodiments, the link test system 114 loads rings of a boundary-scan architecture that is integrated into the devices of the system under test 100 using methodologies described in the Institute of Electrical and Electronics Engineers (IEEE) 1149.1 standard, commonly referred to as JTAG. As is described in greater detail below, scanning information into those rings via the boundary-scan architecture enables the link test system 114 to drive test elements (e.g., built-in self-test (BIST) engines) to execute link tests.

Also contained in memory 108 are one or more scan definition files 116 and a scan database 118. As is described in greater detail below, the scan definition files 116 describe the configuration of the system devices and the manner in which link tests can be initialized for links associated with the devices. The information contained in the scan definition files 116 can, in turn, be used to develop the scan database 118, which defines the relationships between the devices, and their associated links and scan paths.

It is noted that the programs (i.e., logic) described above can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. The programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

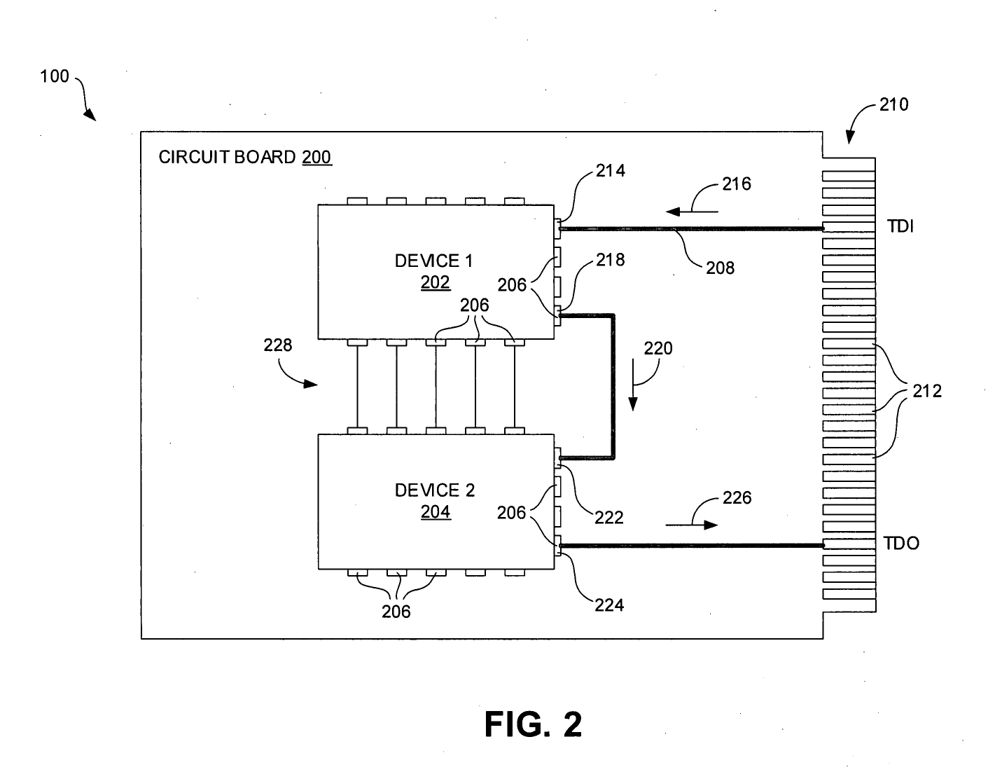

FIG. 2 provides an example embodiment for the system under test 100 of FIG. 1. As is indicated in FIG. 2, the system under test 100 in the illustrated embodiment comprises a circuit board 200 that includes two devices: device 1 (202) and device 2 (204). Although only two such devices are shown in FIG. 2, the circuit board 200 could instead comprise many such devices. Moreover, the system under test 100 can comprise many circuit boards 200, each comprising a plurality of devices.

Each device 202, 204 is a boundary-scan device, meaning that each device is equipped with integral boundary-scan architecture that enables boundary-scan testing in accordance with IEEE 1149.1 to be conducted. In the example of FIG. 2, each device 202, 204 comprises an integrated circuit (IC) chip having a plurality of input/output (I/O) pins 206.

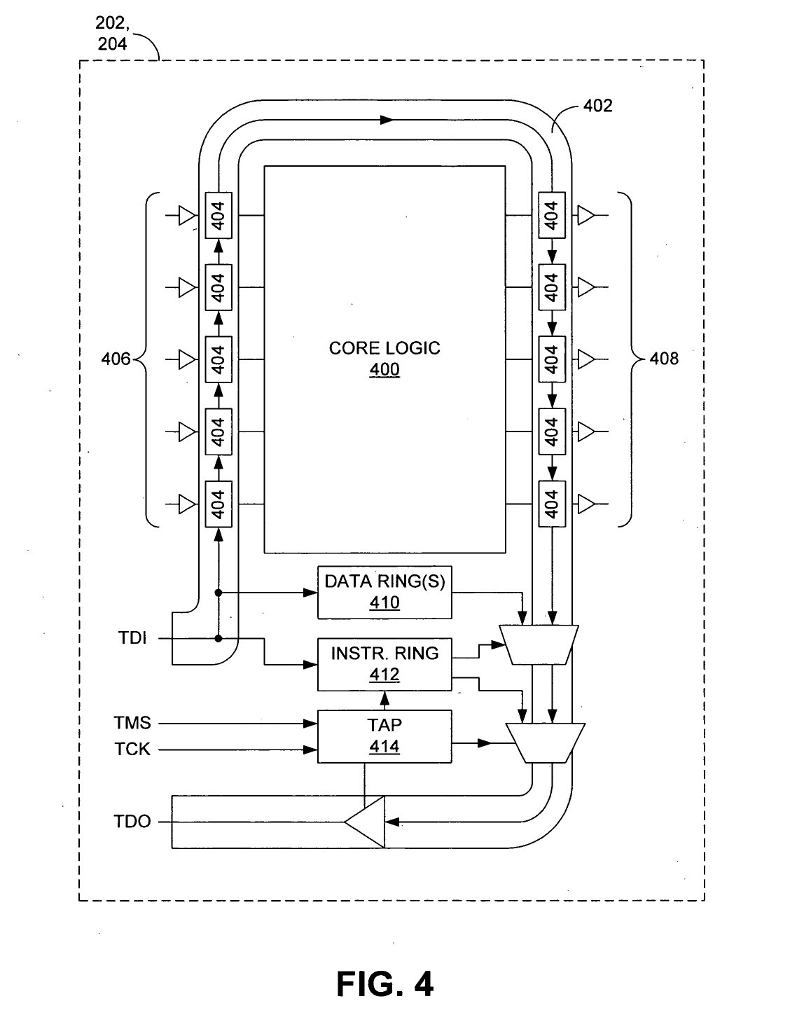

Information can be scanned into the devices 202, 204 using a scan path 208. As is shown in FIG. 2, the scan path 208 extends to and from an edge connector 210 that comprises a plurality of contacts 212. With this arrangement, a test data in (TDI) signal can be input into an input pin 214 of the first device 202 (arrow 216). Test data can then travel through the boundary-scan architecture (see FIG. 4) of the first device 202, out an output pin 218 of the first device, to an input pin 222 of the second device 204 (arrow 220), through the scan architecture (see FIG. 4) of the second device, and out an output pin 224 of the second device so as to be output from the circuit board 200 as test data out (TDO) (arrow 226).

As is also shown in FIG. 2, the system under test 100 comprises a plurality of links 228 that may be tested. In the embodiment of FIG. 2, these links 228 extend between the devices 202, 204, and enable the devices to communicate with each other. In some embodiments, these links may comprise high-speed links. Although FIG. 2 shows links 228 between two devices 202, 204 on a signal board 200, links may also connect devices on different boards or other components.

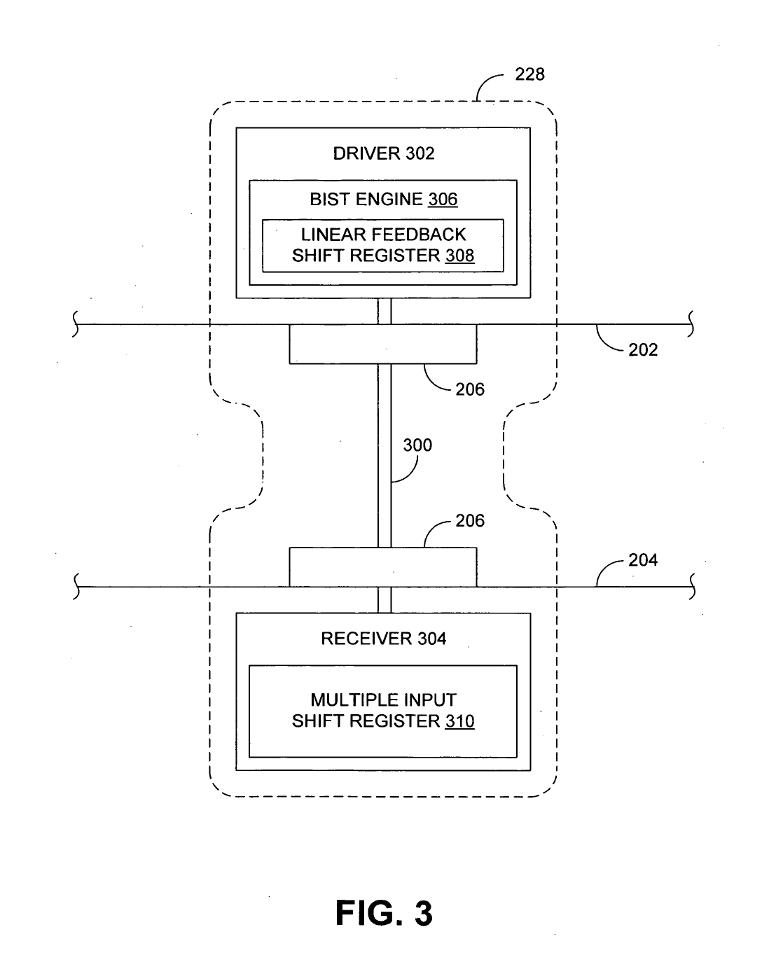

FIG. 3 illustrates an example embodiment for a link 228 of the system under test 100 shown in FIG. 2. As is indicated in FIG. 3, the link 228 extends from the first device 202 to the second device 204. More particularly, the link 228 includes a communication pathway 300 that extends between a pin 206 of the first device 202 to a pin 206 of the second device 204. This communication pathway 300 can comprise any medium along which messages can be transmitted between the devices 202, 204. For example, the communication pathway 300 can comprise a metal conductor wire.

As used herein, the term “link” also includes the logic provided at both ends of the communication pathway 300 to enable communication between the devices 202, 204. In the link embodiment of FIG. 3, this logic comprises a driver 302 that is provided at a first end of the link 228 (in device 202), and a receiver 304 that is provided at a second end of the link (in device 204). The driver 302 includes a BIST engine 306 that comprises a linear feedback shift register (LFSR) 308. As is described in greater detail below, the BIST engine 306 is controlled by the link test system 114 (FIG. 1), which provides information to the BIST engine via the boundary-scan architecture and protocol. As is further depicted in FIG. 3, the receiver 304 comprises a multiple input shift register (MISR) 310, which stores signature information that provides an indication as to whether the link 228 passed or failed its test.

FIG. 4 provides an example embodiment of the architecture for at least one of the devices 202, 204 shown in FIG. 2. More specifically, illustrated is boundary-scan architecture of the device 202, 204. As is shown in FIG. 4, the device 202, 204 includes core logic 400 that comprises the core functionality of the device. Surrounding the core logic 400 is a scan ring 402 that comprises a plurality of scan cells 404. One such cell 404 is provided for each of a plurality of input pins 406 of the device 202, 204, and for each of a plurality of output pins 408 of the device.

Also depicted in FIG. 4 are a data ring 410 and an instruction ring 412. As is described in greater detail below, these rings are used to provide information to the test element (e.g., BIST engine 306, FIG. 3) that will conduct the link test. Test data can be scanned into these rings 410, 412 as input signals (TDI) transmitted along the scan path (e.g., path 208, FIG. 2). In addition, the device 202, 204 includes a test access port (TAP) 414 that receives boundary-scan control signals for the purpose of conducting boundary scanning in accordance with IEEE 1149.1. Those control signals can be input as test mode signal (TMS) and test clock (TCK) signals.

Example systems having been described above, example methods for testing links will now be described. In the discussions that follow, flow diagrams are provided. Any process steps or blocks in these flow diagrams may represent modules, segments, or portions of code that include one or more executable instructions for implementing specific logical functions or steps, in the process. Although particular example process steps are described, alternative implementations are feasible. For instance, some steps may be executed out of order from that shown and discussed depending on the functionality involved.

As is described above, the link test system 114 can be used to control a test element, such as a BIST engine 306, to perform link testing at speed. More particularly, the link test system 114 leverages the boundary-scan architecture and scan paths of the system under test to load various registers associated with the BIST engine 306. Loading of those registers causes the BIST engine 306 to perform a test of its associated link to determine if the link is good or bad. When the BIST engine 306 is controlled in this manner, it generates pseudo-random data that it streams across the link for a predefined period of clock cycles. The streamed data is received at the receiver 304 (e.g., MISR 31, FIG. 3), and that data can be used to determine a signature value that, when compared to an expected value, provides an indication as to whether the link is operating correctly.

Given that the link test system 114 automatically generates the bit streams that are used to load the registers associated with the BIST engine 306, the user, i.e., the person initiating the test, need not have specific knowledge of the architecture of the system under test. Instead, the user can simply identify which link the user would like to be tested, and receive a pass or fail indication from the link test system 114. Moreover, such testing can be conducted without the need to download any specialized code, and before the entire system is completed. Therefore, testing can be performed during the system building process with relatively little effort.

Although it is relatively simple to determine the data to load into device registers for testing links of systems that only comprise a single device along a given scan path, this task is more complex for cases in which several devices are provided on the scan path. In order for the link test system 114 to develop the correct bit streams to provide on the scan path, the configuration of the system under test must be considered a whole. In other words, a system-level scan approach is necessary.

A system-level understanding of the system under test can be obtained using information about the various devices that comprise the system. This information can, in turn, be used to generate a reference database, such as scan database 118 (FIG. 1), that describes the configuration of the system under test. The information used to generate the database can take the form of one or more scan definition files, such as files 116 (FIG. 1). The scan definition files define the system devices (e.g., devices 1 and 2, FIG. 2) and are generated by the system designer, who is most familiar with their architecture. The scan definition files contain information necessary for executing a BIST test, such as how to initialize the link and the scan steps needed to run the test. The following represents the contents of a link section of an example scan definition file:

```
Link Section
    Reference:<link reference>
    Type: <input, output, bidirectional>
    BIST Engine: <scan data>
    Clock: <scan data>
    Chip Init:<scan data>
    Link Setup: <scan data>
    Run Test: <scan data>
    Test Status: <scan data><state values>
    Signature: <scan data><mask data><expect data>
    Pins: <pins>
End
```

Each of the entries in the link section provides part-specific information for a device in the system under test (e.g., device 1, FIG. 2). Each link in the device will have one such section. Most of the entries have a set of scan data associated with them. The scan data can take different forms. One form is to provide a list of scan steps where each step is defined by the type of ring to scan (instruction ring or data ring), the number of bits to scan, and the data to scan. Some entries may be empty, or non-existent if they do not apply to the particular link.

The “Reference” entry identifies the particular type of link at issue. Therefore, the “Reference” entry allows one to describe a link as a processor link, I/O link, memory link, or something else. The “Type” entry indicates if the link is an input, output, or bidirectional link. The “BIST Engine” entry describes the scan steps that are used to load any registers to enable the BIST test operation. This entry may also be used to set registers that are not covered by other entries. The “Clock” entry provides can data that is used to load a register that will control the number of test clocks used during the BIST test. The “Chip Init” entry is used to describe the steps need to initialize the chip before to place it into a state that will enable link testing. The “Link Setup” entry is used to prepare the link interface for testing. For example, the “Link Setup” entry can be used to load test data into the link interface. The “Run Test” entry is a “placeholder” of the scan steps that causes the BIST interface to start the test. The “Test Status” entry provides the data needed to monitor the test. The state values of the entry provide information about the test state data that can be pulled from the interface. The data of the entry is used to poll the interface to determine if a test has been completed and to check for any error condition. The “Signature” entry refers to the end result of the link test. The scan, mask, and expect data are used to pull the signature data from the receiver, and determine if that data matches with expectations. Finally, the “Pins” entry identifies the pins on the device that the given link comprises

As is noted above, the link test system 114 can use the scan definition files to generate a scan database that comprises a representation of the architecture of and relationships between the various devices described by the files. Once the scan database has been constructed, it can be used to facilitate link testing.

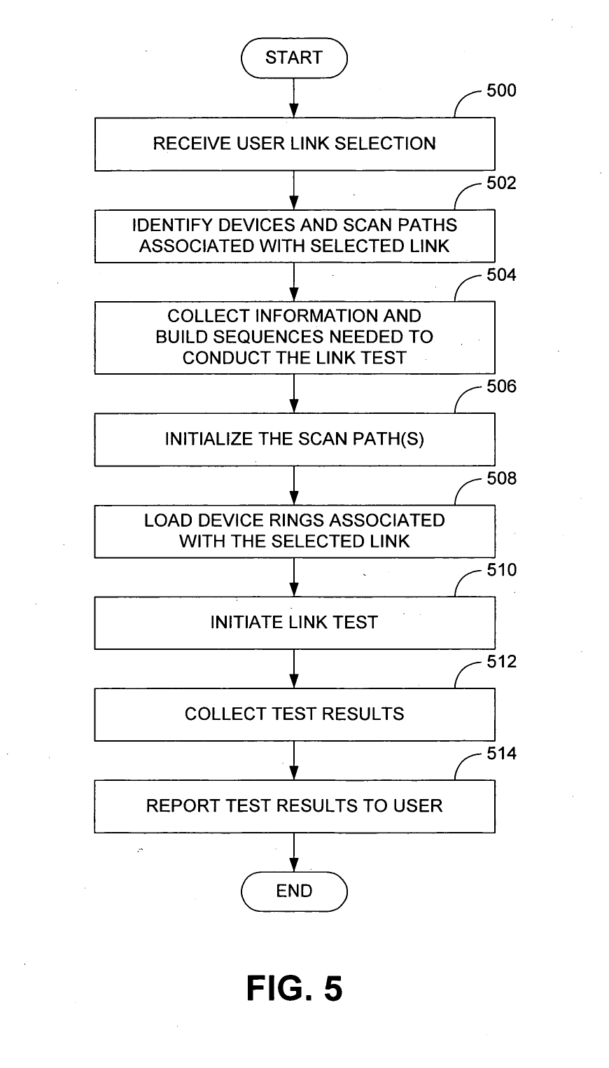

FIG. 5 provides an overview of an embodiment of link testing. For purposes of the following discussion, it is assumed that this method is practiced by the link test system 114. Beginning with block 500, the system 114 receives a user link selection. The link selection provided by the user identifies the link or links that the user would like the system 114 to test.

Next, as indicated in block 502, the link test system 114 identifies all devices and scan paths that are associated with the selected link. After making that identification, the link test system 114 collects information regarding the devices associated with the selected link and builds sequences needed to conduct the link test, as indicated in block 504. As is described below in greater detail, this building can comprise building a link test set-up sequence, building a link run sequence, building a test status check sequence, and building a receiver expect data sequence.

Referring next to block 506, the link test system 114 initializes the scan paths that were identified in block 502. This initialization comprises determining what information is required to scan along each implicated scan path relative to the information that is known about the various devices along the path.

The link test system 114 then loads device rings associated with the selected link, as indicated in block 508. As is described above, these rings may comprise one or more instruction or data rings built into the devices of the system under test.

At this point, the link test can be run. Therefore, the link test system 114 initiates the link test (block 510) by instructing the BIST engine to conduct the test, collects the results of the test from the receiver (block 512), and reports the results of the test to the user (block 514).

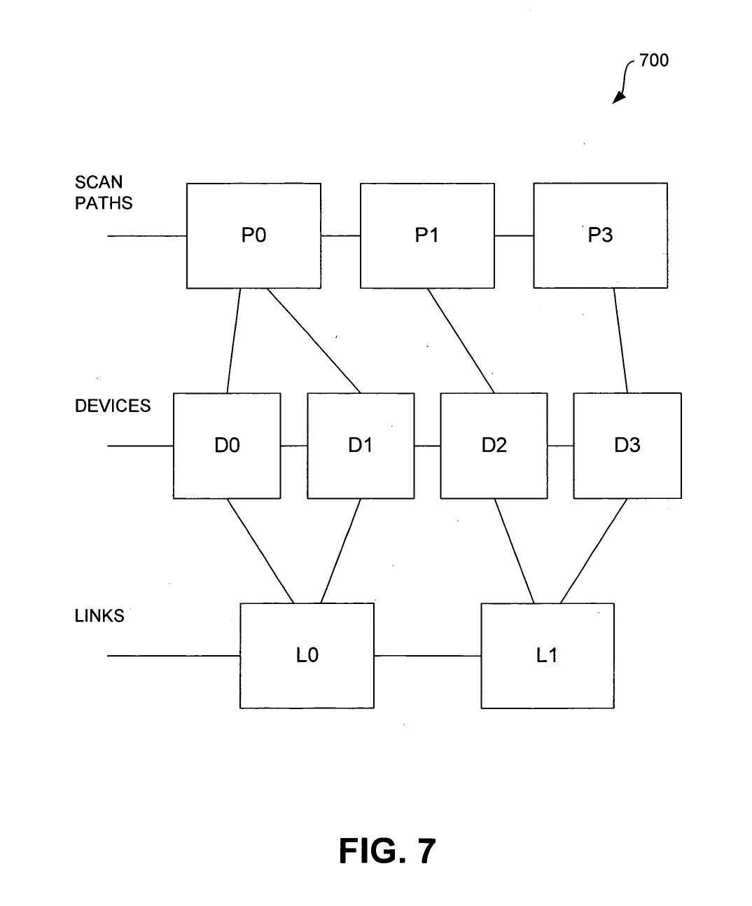

As is described above, the link test system 114 reads data files that enable it to construct the scan database 118 before link testing starts. Part of this database contains elements that model the link structure. FIG. 7 shows an example link model 700 that includes four devices (D0-D3) on three scan paths (P0-P3). There are two links (L0 and L1), each connecting two devices. The link test process involves running a set of code against the model. Thus, a number of different system configurations can be test with the same software. Those different configurations are supported with different data files, not any special test software.

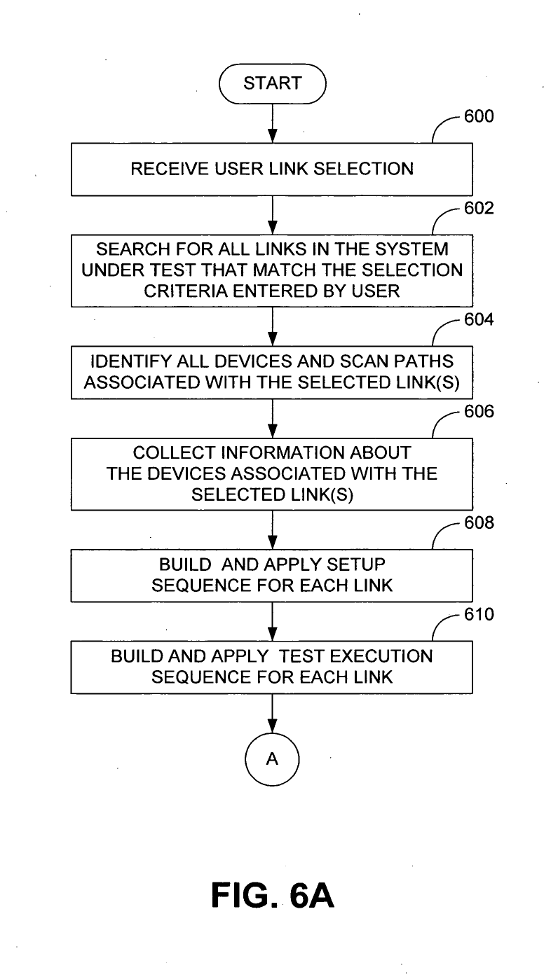

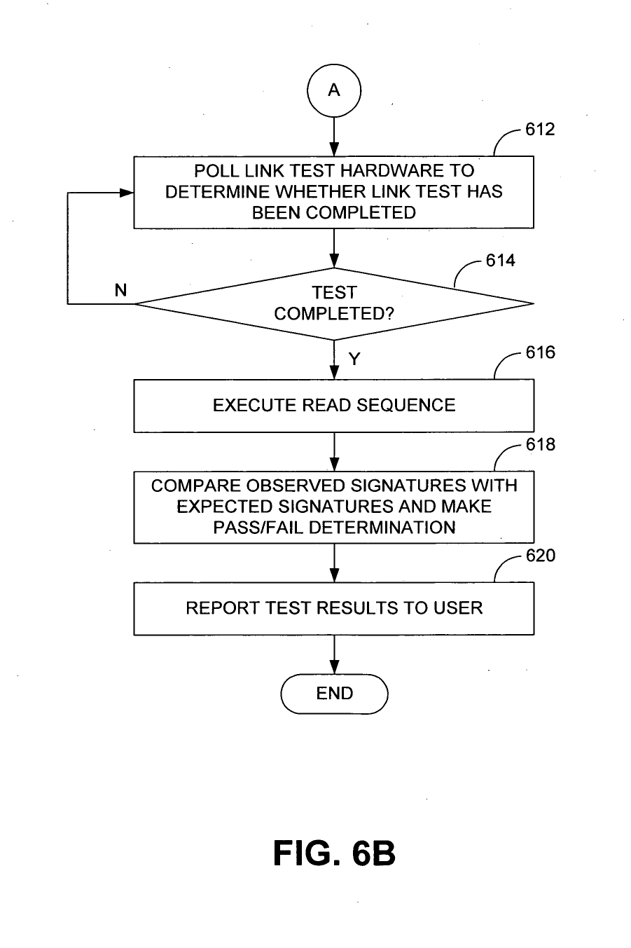

FIGS. 6A and 6B describe a further embodiment of testing links. Beginning with block 600 of FIG. 6A, the system 114 receives a user link selection. More particularly, the user selects some set of links to test at the beginning of the link test process. The user may select an individual link, a group of links, or every link in the system. A number of different methods can be used to make the selection. For example, the user may pick links via a graphical user interface (GUI). Alternatively, the user may identify the link(s) at a command line interface.

Once the link selection is received, the link test system 114 searches for all of the links in the system under test that match selection criteria entered by the user, as indicated in block 602. Specifically, the system 114 examines the scan database 118 and identifies all links that meet the user's criteria.

Through the search of the scan database 118, the link cans system 114 can identify all of the devices and scan paths that are associated with the selected links, as indicated in block 604, and therefore all of the devices and scan paths that will be involved in the link test. For purposes of example, consider the link model 700 of FIG. 7. If the user selected link L0 to test, then the system 114 at this point would determine that devices D0 and D1 will need to be scanned. The model 700 further indicates that the system 114 will need to scan path P0 in order to load link test data into devices D0 and D1.

Referring next to block 606 of FIG. 6A, the link test system 114 collects, as to each link, the information that pertains to each device associated with the link. For example, once the system 114 knows what devices are involved in the test, the system can refer to the link sections of the scan definition files. At this point, the system 114 can build and execute scan sequences. There are multiple ways to order the process. One way is to build all of the data necessary first and then perform the scan operations. Another way is to only build the data just before the scan operation must happen.

Before test data is run over the links, it may be necessary to initialize the system under test 100. For example, the ink test system 114 may need to reset the system under test 100 to ensure that tests can be run. Furthermore, it may be necessary to load scan data into the chip to place it into a state ready for testing. Another aspect of initialization is related to the link itself. The link architecture may require loading data into key registers to enable the link test. For example, one may need it initialize some clock controls. Also, it might be necessary to turn off error checking so that the link does not shut down as the test data is moved across it. These steps may be described as building the link test setup sequence (block 608) and involve the system 114 taking the appropriate scan data from the scan definition files and scanning it into the system under test 100. For each initialization scan sequence, the system 114 will consider what data is associated with each device. In the example of FIG. 7, there will be data for devices D0 and D1. The system 114 will recognize that both devices exist on the same path (i.e., path P0), and will build the scan data patterns to send into the hardware appropriately.

After building the link test setup sequence, the link test system 114 builds the link run sequence, as indicated in block 610. Specifically, the link test systems 114 builds the test patterns needed to execute the scan link test. Next, they system 114 loads the run test data sequences into the selected devices. At this point, the link test begins running. The BIST engines associated with the selected links then, sequentially or in parallel, stream data across their associated links for the duration of time (i.e., number of clock cycles) specified in the relevant scan definition file.

The link test system 114 needs to know when the test is finished. Therefore, the system 114 polls the link these hardware (e.g., drivers) to determine whether the link test has been completed, as indicated in block 612. By way of example, the test status entry in the link section is used to determine how to poll the link test hardware. Appropriate scan data sequences are pushed into the system in order to extract status data. For example, the system 114 can periodically poll the hardware in a continual loop until the tests are completed (block 614), or until errors are detected.

Upon completion of the test, flow continues to block 616 at which the link test system 114 executes a read sequence to obtain signature information from all receivers associated with a link that has been tested. The signature scan data from the link section of the scan definition files are used by the link test system 114 to build the appropriate data patterns to scan into the scan paths in order to extract the signature data form the receivers (e.g., from MISRs 310, FIG. 3). There will be a signature for each tested link.

Once the signature values are obtained, the system 114 can compare the observed signatures with the expected signatures as to each link and make a pass or fail determination, as indicated in block 618. If an observed signature does not exactly match an expected signature, the link has failed the test.

Once the pass/fail determination has been made, the link test system 114 reports the test results to the user, as indicated in block 620. By way of example, the results can be presented to the user in the same GUI with which the user selected the links to test.

What is claimed is:

1. A method for testing links, comprising:
identifying devices that are associated with a selected link;
collecting information about the configuration of the identified devices;
building test sequences for testing the selected link based upon the collected information; and
controlling, via boundary-scan architecture, an internal test element to test the selected link.

2. The method of claim 1, wherein said identifying devices comprises searching a scan database for devices associated with the selected link.

3. The method of claim 1, wherein said collecting information about the configuration of the identified devices comprises collecting information from at least one scan definition file.

4. The method of claim 1, wherein said building test sequences comprises automatically building test sequences based upon the collected information that define the manner in which the link testing is performed.

5. The method of claim 4, wherein said building test sequences comprises at least one of building a link test setup sequence, building a link run sequence, building a test status check sequence, and building a receiver expect sequence.

6. The method of claim 1, wherein said controlling an internal test element comprises controlling a built-in self-test (BIST) engine comprised by a driver of the selected link.

7. The method of claim 6, wherein said controlling a BIST engine comprises causing the BIST engine to stream data across the link to a receiver.

8. The method of claim 6, wherein said controlling an internal test element comprises loading internal rings associated with the BIST engine with data that controls operation of the BIST engine.

9. The method of claim 8, wherein said loading internal rings comprises loading the internal rings using a test data in (TDI) signal transmitted on a scan path in accordance with the JTAG standard.

10. The method of claim 1, further comprising reading data collected by a receiver of the selected link to extract a signature value.

11. The method of claim 10, further comprising comparing the signature value with an expected signature to determine whether the selected link passed the test.

12. A system for testing links, comprising:
means for collecting information about the configuration of devices associated with a selected link;
means for automatically building test sequences for testing the selected link based upon the collected information; and
means for controlling, via boundary-scan architecture, an internal test element to test the selected link.

13. The system of claim 12, wherein the means for automatically building test sequences comprise means for automatically building a link test setup sequence, a link run sequence, a test status check sequence, and a receiver expect sequence.

14. The system of claim 12, wherein the means for controlling an internal test element comprise means for controlling a built-in self-test (BIST) engine.

15. The system of claim 14, wherein the means for controlling an internal test element comprise means for loading internal rings associated with the BIST engine.

16. The system of claim 15, wherein the means for loading internal rings comprise means for loading the internal rings using a test data in (TDI) signal transmitted on a scan path in accordance with the JTAG standard.

17. The system of claim 12, further comprising means for reading data collected by a receiver of the selected link to extract a signature value.

18. The system of claim 17, further comprising means for comparing the signature value with an expected signature to determine whether the selected link passed the test.

19. A link test system stored on a computer-readable medium, the system comprising:
logic configured to identify all devices and scan paths associated with a user-selected link;
logic configured to automatically build test sequences for testing the user-selected link;
logic configured to control, via boundary-scan architecture, an internal test element associated with the user-selected link to test the link.

20. The system of claim 19, wherein the logic configured to identify all devices is configured to search for the devices in a scan database.

21. The system of claim 19, wherein the logic configured to automatically build test sequences is configured to build at least one of a link test setup sequence, a link run sequence, a test status check sequence, and a receiver expect sequence.

22. The system of claim 19, wherein the logic configured to control an internal test element is configured to control a built-in self-test (BIST) engine comprised by a driver of the selected link.

23. The system of claim 22, wherein the logic configured to control an internal test element comprises logic configured to load internal rings associated with the BIST engine.

24. The system of claim 24, wherein loading internal rings comprises loading the internal rings using a test data in (TDI) signal transmitted on a scan path in accordance with the JTAG standard.

25. The system of claim 19, further comprising logic configured to read data collected by a receiver of the selected link to extract a signature value.

26. The system of claim 25, further comprising logic configured to compare the signature value with an expected signature to determine whether the selected link passed the test.

27. A computer system, comprising:
a processing device; and
memory that includes a link test system, the link test system being configured to identify all devices and scan paths associated with a user-selected link, to automatically build test sequences for testing the user-selected link, and to control, via boundary-scan architecture, an internal test element associated with the user-selected link to test the link.

28. The system of claim 27, wherein the link test system is configured to control a built-in self-test (BIST) engine comprised by a driver of the selected link.

29. The system of claim 27, wherein the link test system is configured to load internal rings associated with the BIST engine.

30. The system of claim 29, wherein the link test system is configured to load the internal rings using a test data in (TDI) signal transmitted on a scan path in accordance with the JTAG standard.

31. The system of claim 27, wherein the link test system is configured to read data collected by a receiver of the selected link to extract a signature value.

32. The system of claim 32, wherein the link test system is configured to compare the signature value with an expected signature to determine whether the selected link passed the test.
